(19) United States
(12) Patent Application Publication
(10) Pub. No.: US 2009/0151520 A1
(43) Pub. Date: Jun. 18, 2009

(54) SOCKET FOR WRENCHES

(76) Inventor: Shyh-Ming Wang, Taichung Hsien (TW)

Correspondence Address: Shyh-Ming Wang, No.37-2, Ching-Dau 1st Street, Taichung, 404, TW

(21) Appl. No.: 12/368,296

(22) Filed: Feb. 9, 2009

Related U.S. Application Data
(63) Continuation-in-part of application No. 11/396,842, filed on Apr. 4, 2006.

(51) Int. Cl. B25B 13/02

(52) U.S. Cl. 81/125

(57) ABSTRACT

This present invention discloses a socket for wrenches, which comprises a main body having a proximal section, a distal section, and a central axis extending from proximal section to distal section. The main body has recess at inside on the proximal section with punctures on the recessed periphery and each puncture has a moving part mounted therethrough. A sleeve is in slide-fitting communication with the main body, which has an inner wall provided a plurality of push fronts thereon, each push front surface rises gradually by a plurality of continuous steps from one end to the other. When the sleeve is rotated of axially moved with respect to the main body, the gradual rising steps of the push fronts are pushing the moving parts toward the central axis to match with varieties of scales of work pieces.

### RELATED APPLICATION

This application is a Continuation-in-Part of U.S. application Ser. No. 11/396,842, entitled “SOCKET FOR A WRENCH”, naming Shyh-Ming Wang as inventor, and filed on Apr. 4, 2006.

### FIELD OF THE INVENTION

The present invention is relates to a socket of wrenches, and more particularly to a socket with a simplified structure that can effectively and exactly match with varieties of scales of work pieces by steps.

### BACKGROUND OF THE INVENTION

As what had been acknowledged, the current patent of common size and structure adjustable wrench sleeves such as U.S. Pat. No. 6,374,710 is using the retractable effect of a plurality of pillar posts mounted inside the sleeve to match with varieties of specifications of work pieces. The structure is more than complicated, quite a number of elements (such as sleeve 1, pillar post 3, retaining rod 4 and retraction spring 5) are required and necessary to be accommodated into sleeve 1, which needs higher cost in manufacturing and is presumed inconvenient to use because aligning is required when using it.

U.S. Pat. Nos. 1,471,451 and 3,698,267 are also about couplings of varieties of specifications, which are similar concept in structure design to the above-mentioned U.S. Pat. No. 6,374,710 and bear the same shortages in use. U.S. Pat. No. 2,387,339 and No. 4608887 are sockets with complicate threaded structure and clamp the workpiece by radial and axial movement. And U.S. Pat. No. 5,927,160 has no the function for matching with varieties of scales of work pieces.

### SUMMARY OF THE INVENTION

This invention comprises a main body that has a proximal section and a distal section; the central axis of the proximal section extends to the distal section. The main body has recess at inside on the proximal section with punctures on the recessed periphery; each puncture has a moving part mounted therethrough. A sleeve is in slide-fitting communication with the main body; inner wall of the sleeve has a plurality of push fronts, each push front surface rises gradually from one end to the other. When the sleeve is rotating or axially moving with respect to the main body, the gradual rising push fronts are pushing the moving parts toward the central axis to match with varieties of scales of work pieces by steps.

### BRIEF DESCRIPTION OF THE DRAWINGS

FIG. 1 is an exploded perspective of the present invention;

FIG. 2 is an assembly appearance of FIG. 1;

FIG. 3 is a side view of FIG. 2;

FIG. 4 is the cross-sectional view, taken along line A-A in FIG. 3;

FIG. 5 is the motion diagram of moving part with respect to FIG. 4;

FIG. 6 is the cross-sectional view, taken along line B-B in FIG. 3; and

FIG. 7 is another distributed embodiment of the push front of the present invention.

### DETAILED DESCRIPTION OF THE PREFERRED EMBODIMENT

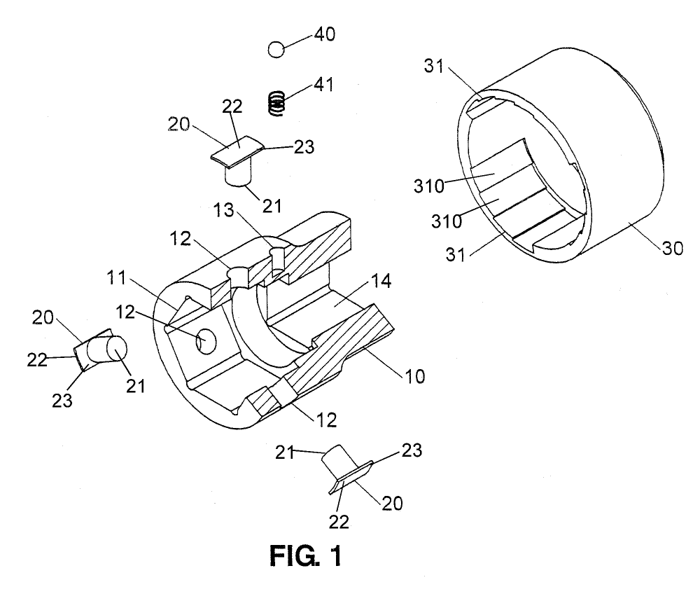

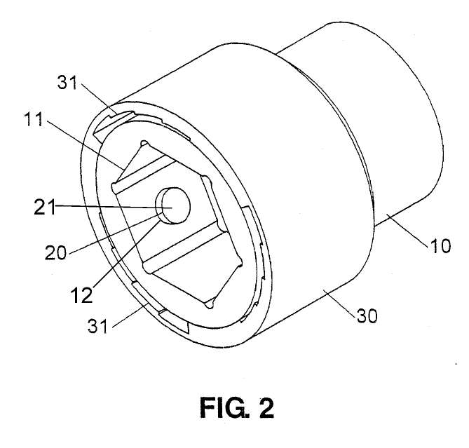

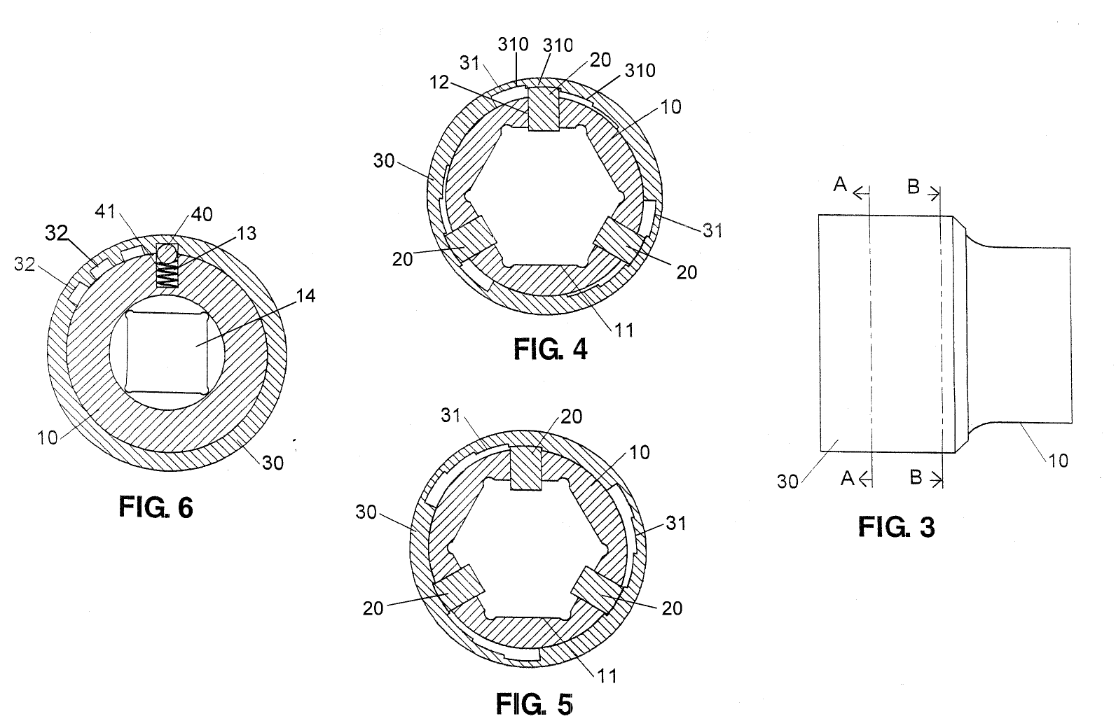

As shown in FIGS. 1 to 7, this invention comprises a main body 10 that has a proximal section, a distal section provided with a square receiving hole 14 for a driving spanner to connect to, and a central axis extending from the proximal section extends to the distal section. The main body 10 has a recess 11 on the proximal section provided three radially extending punctures 12 thereon connecting with the recess 11; each puncture 12 has a moving part 20 only radial-direction movably (i.e. radially movably) mounted therethrough, the moving part 20 has a primary end formed a plane surface 21 and a secondary end formed a first arc surface 22. A sleeve 30 has an inner wall and is in slide-fitting communication with the outside of the main body 10, which has its central axis parallel with the central axis of the main body 10. The inner wall of the sleeve 30 has three push fronts 31 each corresponding to one moving part 20, each push front 31 contacts with the first arc surface 22 of the secondary end of the moving part 20, the surface of each push front 31 rises gradually by a plurality of continuous steps from one end to the other. When the sleeve 30 is moved (rotated or axially moved) with respect to the main body 10, the gradual rising push fronts 31 are pushing the moving parts 20 toward the central axis (comparing with FIGS. 4 and 5), and then a work piece with smaller scale can be fitted into.

As shown in FIGS. 1 and 6, a ball groove 13 is implemented on the periphery of the main body 10 with a spring 41 and a sphere 40 mounted thereinto. There is a plurality of cavities 32 on the inner wall of the sleeve 30, which are implemented to have the sphere 40 to be positioned in to. The push front 31 on the inner wall of the sleeve 30 is shaped as continuous steps 310, and the distance of the center of two adjacent cavities 32 is equal to the distance of the center of two adjacent steps 310 of each push front 31, each step 310 formed by a second arc surface with a radius being equal to the radius of the first arc surface 22 of the moving part 20, so that each step 310 can exactly and effectively touch with the first arc surface 22 of the secondary end of the moving part 20.

As shown in FIG. 4, the outline of the recess 11 is in the shape of polygon in the view of cross-section which is vertical with respect to the central axis. And the embodiment in FIG. 4, the polygon is a hexagon.

As shown in FIG. 1, the secondary end of the moving part 20 connects with a rigid plate 23 and the first arc surface 22 formed thereon, so that the moving part 22 formed to be a thin body, and remain the first arc surface 22 having a big dimension so as to exactly and effectively touch with the step 310.

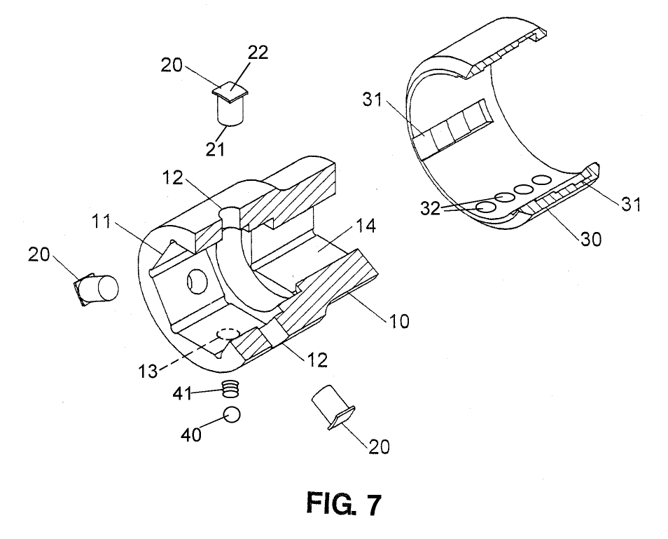

According to mentioned previously, the sleeve 30 of the present invention can be rotated or axially moved with respect to the main body 10, the gradual rising push fronts 31 will push the moving parts 20 toward the central axis of the main body 10, and then a workpiece with smaller scale can be fitted into. With respect to rotate mode, as shown in FIGS. 1, 4 and 5, the steps 310 of each push front 31 are annularly distributed along the second central axis, the gradual rising push fronts 31 can push the moving parts 20 toward the central axis when the sleeve 30 is rotated with respect to the main body 10. With respect to axially move mode, as shown in FIG. 7, the steps 310 of each push front 31 are axially distributed along the second central axis, the gradual rising steps 310 of the push fronts 31 can push the moving parts 20 toward the central axis when the sleeve 30 is axially moved with respect to the main body 10.

While we have shown and described the embodiment in accordance with the present invention, it should be clear to those skilled in the art that further embodiments may be made without departing from the scope of the present invention.

What is claimed is:

1. A socket for wrenches comprises:
a main body having a proximal section, a distal section, and a central axis extending from the proximal section to the distal section, the distal section having a square receiving hole, the proximal section having a recess connecting with the square receiving hole and three radially extending punctures connecting with the recess, the outline of the recess being in the shape of hexagon in the view of a cross-section which is vertical with respect to the central axis, each puncture having a moving part radially movably mounted therethrough, the moving part having a primary end formed a plane surface and a secondary end formed a first arc surface; a ball groove is implemented on the periphery of the main body with a spring and a sphere mounted therein; and
a sleeve having an inner wall and being in slide-fitting communication with the outside of the main body, and having a second central axis parallel with the central axis of the main body, the inner wall of the sleeve provided three push fronts thereon each corresponding to one moving part, wherein the push front on the inner wall of the sleeve shaped as continuous steps, the steps of each push front rising gradually from one end to the other, and the inner wall of the sleeve provided a plurality cavities thereon, the cavities implemented to have the sphere to be positioned thereinto, and the distance of the center of two adjacent cavities is equal to the distance of the center of two adjacent steps of each push front;
so that the steps of the push fronts can push the moving parts toward the central axis by steps when the sleeve is moved with respect to the main body.

2. The socket as claimed in claim 1, wherein each step formed by a second arc surface with a radius being equal to the radius of the first arc surface of the moving part.

3. The socket as claimed in claim 1, wherein the secondary end of the moving part connected with a rigid plate and the first arc surface formed thereon.

4. The socket as claimed in claim 1, wherein the steps of each push front are annularly distributed along the second central axis, the gradual rising push fronts can push the moving parts toward the central axis when the sleeve is rotated with respect to the main body.

5. The socket as claimed in claim 1, wherein the steps of each push front are axially distributed along the second central axis, the gradual rising push fronts can push the moving parts toward the central axis when the sleeve is axially moved with respect to the main body.

6. A socket for wrenches comprises:
a main body having a proximal section, a distal section, and a central axis extending from the proximal section to the distal section, the distal section having a square receiving hole, the proximal section having a recess connecting with the square receiving hole and three radially extending punctures connecting with the recess, each puncture having a moving part only radial-direction movably mounted therethrough, the moving part having a primary end formed a plane surface and a secondary end formed a first arc surface; a ball groove is implemented on the periphery of the main body with a spring and a sphere mounted therein; and
a sleeve having an inner wall and being in slide-fitting communication with the outside of the main body, and having a second central axis parallel with the central axis of the main body, the inner wall of the sleeve provided three push fronts thereon each corresponding to one moving part, wherein the push front on the inner wall of the sleeve shaped as continuous steps, the steps of each push front rising gradually from one end to the other, and the inner wall of the sleeve provided a plurality cavities thereon, the cavities implemented to have the sphere to be positioned thereinto, and the distance of the center of two adjacent cavities is equal to the distance of the center of two adjacent steps of each push front;
so that the steps of push fronts can push the moving parts toward the central axis by steps when the sleeve is moved with respect to the main body.

7. The socket as claimed in claim 6, wherein each step formed by a second arc surface with a radius being equal to the radius of the first arc surface of the moving part.

8. The socket as claimed in claim 6, wherein the secondary end of the moving part connected with a rigid plate and the first arc surface formed thereon.

9. The socket as claimed in claim 6, wherein the steps of each push front are annularly distributed along the second central axis, the steps of the push fronts can push the moving parts toward the central axis when the sleeve is rotated with respect to the main body.

10. The socket as claimed in claim 6, wherein the steps of each push front are axially distributed along the second central axis, the steps of the push fronts can push the moving parts toward the central axis when the sleeve is axially moved with respect to the main body.

11. The socket as claimed in claim 6, wherein the outline of the recess is in the shape of hexagon in the view of a cross-section which is vertical with respect to the central axis.
